(19) United States
(12) Patent Application Publication
(10) Pub. No.: US 2017/0214671 A1
(43) Pub. Date: Jul. 27, 2017

(54) METHOD FOR ENCRYPTING AND DECRYPTING DATA WITH A ONE-TIME-KEY

(71) Applicant: befine Solutions AG, Freiburg (DE)

(72) Inventors: Dominik LEHR, Freiburg (DE); Mark FORREST, Henley-on-Thames (GB); Matthias KESS, Gerlingen (DE)

(73) Assignee: befine Solutions AG, Freiburg (DE)

(21) Appl. No.: 15/413,624

(22) Filed: Jan. 24, 2017

(30) Foreign Application Priority Data
Jan. 26, 2016 (DE) 10 2016 101 363.3

(51) Int. Cl. H04L 29/06; H04L 9/08

(52) U.S. Cl. CPC H04L 63/067; H04L 9/0869; H04L 63/0435; H04L 63/0471; H04L 2463/061

(57) ABSTRACT

A method for encrypting and decrypting data with a session key is proposed. The data is exchanged between a first data processing device and a second data processing device via a communications link that is equipped with a communications server. The method exhibits process steps concerning the generation of a permanent common start value and the provision of a formation rule for the session key, process steps concerning the generation of a session key for the encryption of the data, process steps concerning the encryption of data of the first data processing device using the session key, process steps concerning the generation of a session key for decryption of the data and process steps concerning the decryption of the data.

The invention derives from a method for encrypting and decrypting data which is exchanged between a first data processing device and a second data processing device, with a session key, wherein the first data processing device is connected to the second data processing device via a communications link and the communications links exhibits a communications server.

In a data exchange, data is exchanged between a first data processing device and a second data processing device via a communications link. Here, the communications link connects the first and the second data processing device with each other. The communications link is equipped with a communications server on which the data is stored during the data exchange and from which it can then be retrieved. The first and the second data processing device and the communications link are normally part of a data network in which other data processing devices participate. To protect the data exchanged between the first and the second data processing device against undesirable or unauthorised access by third parties, the data is first encrypted and then decrypted again. In a symmetrical encryption method a common key with which the data is encrypted and decrypted is agreed between the users of the first data processing device participating in the data exchange and of the second data processing device that is also participating. In an asymmetrical encryption method such as S/MIME, PGP and SFTP, several keys are used, for example one public and one private key per data processing device.

The generation and exchange of a key are decisive for the security of an encryption method. User friendliness is also of huge significance. If the generation or exchange of the key or keys is so complex that they involve considerable effort for a user or a group of users, acceptance is undermined.

If one key is used for several communication processes that involve a data exchange, the risk that third parties may come to know the key increases. To prevent this, the keys are generated as session keys which are each used only for one communication process. A communication process comprises the encryption of data, the storage of this encrypted data on the communications server, and the decryption and retrieval of this data from the communications server. If data is encrypted, stored, decrypted and retrieved again, this constitutes a further communication process. For each additional communication process the users of the first and the second data processing device must generate and exchange a new session key or agree several session keys in advance. A session key can also be referred to as session password. Additional devices or equipment may be used for generating session keys. These include for example special key or password generators such as tokens, or application software for a mobile phone. This additional effort in advance of a data exchange is often a deterrent for users or clients to perform encryption of the data.

The invention is based on the task of providing a method for encrypting and decrypting data with a session key, where session keys are generated automatically without the need for the session keys to be exchanged between a first and second data processing device, without the users of the first and second data processing device needing to devise and agree session passwords or session keys and without additional devices or equipment for generating session keys being needed.

This task is solved by a method according to claim 1. The method is characterised in that a start value is exchanged before the first data exchange between the first and the second data processing device. The method exhibits process steps
concerning the generation of a shared start value and the provision of a formation rule,
concerning the generation of a session key,
concerning the encryption of data of the first data processing device using the session key,
concerning the formation of the session key for decryption of the data and
concerning the decryption of data with the session key.

The process steps concerning the generation of a start value take place between two data processing devices before the first exchange of encrypted data. Here, in the first data processing device a start value is generated, saved and output to the second data processing device, where it is equally saved. Output of the start value from the first to the second data processing device takes place preferably along a secure path. This need not be the communications link, equipped with the communications server, along which the first and second data processing device exchange data encrypted. It may also be a different communications link. For example the start value may be exchanged between the users of the first and second data processing device by e-mail, telephone, post or face to face.

After exchange of the start value, the same start value is saved in the first data processing device and in the second data processing device. By generating, saving and exchanging the start value, the first and second data processing devices document that they would permanently like to exchange data that is encrypted with automatically generated session keys.

The start value is permanently saved in the first data processing device and in the second data processing device. It is used for several communication processes where data is exchanged encrypted between the first and second data processing device. Generation and exchange of a start value therefore take place once, before the first exchange of encrypted data between a first and a second data processing device.

In addition, a formation rule is provided and saved on the communications server, which is part of the communications link between the first and second data processing device. This formation rule is used to generate a session key at least from the start value and a random value generated in the communications server for a communication process.

A communication process comprises the encryption of data from the first data processing device with the session key, the saving of this encrypted data on the communications server, the decryption of this data with the session key and the output of the data from the communications server to the second data processing device.

A clear assignment is laid down here by the formation rule. The formation rule means an identical session key is always generated from two matching start values and two matching random values.

All other process steps of the method according to the invention take place in every communication process where data is exchanged encrypted between a first data processing device and a second data processing device.

The special attribute is that a new random value is generated for every communication process by the communications server, that a session key is generated from the start value of the first data processing device and the random value of the communications server using the formation rule, and that the data is encrypted with this session key and the encrypted data is then saved on the communications server. The session key is then deleted. The random value is saved in the communications server. To decrypt the data, a session key is again generated from the saved random value of the communications server and the start value of the second data processing device, using the formation rule. If the start value and random value match the encryption process, the same session key as for encryption is generated in decryption. The encrypted data is decrypted with this session key and output to the second data processing device. The session key and the random key are then deleted. For a subsequent communication process, a new random value is generated in the communications server.

Here, the generation of the session key for the encryption of the data can take place on the communications server or in the first data processing device. The encryption of the data can in addition take place in the first data processing device or on the communications server. Finally, the generation of the session key for the decryption of the data can take place on the communications server or in the second data processing device. Decryption of the data with the session key can take place on the communications server or in the second data processing device.

Here, the session key cannot be formed solely by the first data processing device, solely by the communications server or solely by the second data processing device. The start value and a random value are always needed for the generation of a session key. Because the start value is permanently saved only in the first and second data processing device and the random value is permanently saved for a communication process only in the communications server, the session key can only be formed jointly by the first data processing device and the communications server or jointly by the second data processing device and the communications server.

The data intended for the data exchange is provided by the first data processing device. It is either first encrypted with the session key and then output encrypted to the communications server or first output unencrypted to the communications server and then encrypted by the communications server. It is then saved encrypted on the communications server, at least until it is output to the second data processing device. After output of the data to the second data processing device, the data is preferably deleted from the communications server.

It may be envisaged that the first data processing device notifies the communications server if it has saved a start value and provided data for encryption and output to the second data processing device. In response the communications server generates a random value for this communication process and saves this at least for the duration of the communication process. In dialogue between the first data processing device and the communications server, using the formation rule a session key is generated from the start value saved in the first data processing device and the random value generated by the communications server for this communication process. The data provided by the first data processing device is then encrypted with this session key. This encrypted data is saved on the communications server.

Preferably the first data processing device or the communications server notifies the second data processing device that encrypted data from the first data processing device is saved on the communications server and that this data is intended for output to the second data processing device. In addition it is possible for the second data processing device to query the communications server at regular intervals whether data intended for it is saved on the communications server. This is referred to as the polling mechanism. The second data processing device then receives a message in response to its query.

To decrypt and retrieve this data, in dialogue between the second data processing device and the communications server a session key is generated from the start value saved in the second data processing device and the random value saved by the communications server for this communication process. Because the start value saved in the second data processing device matches the start value saved in the first data processing device and the communications server for this communication process has the random value generated when encrypting the data available, upon decrypting the same session key as in encrypting is generated with the formation rule. The encrypted data saved on the communications server is decrypted with this session key and retrieved from the communications server by the second data processing device.

In the same way, data is made available by the second data processing device, encrypted with a session key, saved on the communications server, decrypted again and retrieved by the first data processing device. The data exchange may also take place in the opposite direction.

If the start value saved in the second data processing device does not match the start value in the first data processing device, in dialogue between the second data processing device and the communications server a different session key is generated to the session key generated in dialogue between the first data processing device and the communications server and with which the data was encrypted. The result is that the encrypted data cannot be decrypted with the session key generated by the second data processing device and the communications server. Therefore the second data processing device cannot decrypt and retrieve the data saved on the communications server. This prevents access to the data by an unauthorised party.

The communications server has the same random value available for a communication process between the first and second data processing device. This value is generated by the communications server when encrypting the data and saved at least until the encrypted data has been decrypted and retrieved.

Using the formation rule, the same session keys are generated from matching random values and matching start values. This ensures that the session key generated for encryption matches the session key generated for decryption if the start value and random value are the same.

For each additional communication process between the first and second data processing device, the communications server generates a new random value. The start value remains the same. Using the formation rule, a new session key is generated from the new random value and the unchanged start value. The result is that a new session key is available for every communication process.

The random value is formed according to a random principle. This may be an intrinsically known random principle or a known random function.

The formation rule is used to generate a session key at least from the start value and a random value. Additional parameters may be applied in generating the session key.

If a start value is exchanged before or upon initial exchange of encrypted data between the first and the second data processing device, for every additional communication process where data is exchanged between the first and second data processing device, new session keys are generated automatically without the users of the first and second data processing device needing to provide input. The session keys are formed in dialogue with the communications server in such a way that the session keys do not need to be exchanged between the first and second data processing device.

The start value needed to form the session key is saved non-centrally in the first and second data processing device, not on the communications server. This increases security. The start value is therefore protected against undesirable or unauthorised access by third parties just as effectively as the data that is exchanged between the first and the second data processing device.

The session key of a communication process differs from the session key of the previous communication process.

With the method according to the invention, session keys are generated automatically without the users of the first and second data processing device needing to think up or remember the session keys. The session keys are generated in such a way that apart from the exchange of the start value performed before or during the first data exchange, the users do not notice the generation of the session keys, the encryption and the decryption of the exchanged data. Additional devices or equipment for generating the session keys are not necessary. The method according to the invention is therefore simple in its implementation, use and realisation. This promotes user friendliness and acceptance by the user.

Before the first data exchange, the user of the first data processing device, hereinafter first user, can ask the user of the second data processing device, hereinafter second user, whether the second user would like to exchange data with the first user by permanently secure means, using automatically generated session keys. If the second user agrees, the first user prompts the first data processing device to generate a start value and to send this to the second data processing device. The start value is permanently saved in the second data processing device. Alternatively the first user can generate a start value even before asking the second user, save this in the first data processing device and send the start value together with the enquiry to the second user. If the second user agrees, the start value is permanently saved in the second data processing device. If the second user declines, the start value is not saved in the second data processing device and deleted from the first data processing device.

The exchange of a start value between the first and second data processing device and the encryption of data need not take place immediately after one another. There may be a longer period of time between the exchange of a start value and the first exchange of encrypted data.

Equally, decryption and retrieval of the data from the communications server need not take place immediately after the encrypted data has been placed on the communications server. There may be a longer period of time between encryption and decryption of the data.

Different variants for generating the session key for encrypting the data, different variants for encrypting the data with the session key, different variants for generating the session key for decrypting the data and different variants for decrypting the data with the session key are envisaged. Each of the variants differs in respect of where the session key is generated and where the data is encrypted or decrypted. In each case this may take place in one of the two data processing devices or on the communications server. The session key need not necessarily be generated where encryption or decryption takes place. After generation on the first data processing device or the communications server, the session key may also be output to the other device with the result that encryption takes place there. The same applies for decryption of the data.

Each of the variants for generating a session key for encrypting data can be combined with each variant for encrypting the data. Each of the variants for encrypting the data can be combined with each of the variants for generating a session key for decrypting the data. Each of the variants for generating a session key for decrypting the data can be combined with each variant for decrypting the data. This creates a large number of possible combinations.

According to an advantageous embodiment of the invention, a start value key for encrypting the start value is generated. The start value is encrypted by the first data processing device with the start value key before it is output to the second data processing device. The start value key is preferably entered in the second data processing device along a channel of communication that differs from the communications link. The encrypted start value is decrypted with the start value key in the second data processing device. A first user and a second user can agree the start value key orally, for example. The exchange of the start value key can occur face to face or by telephone, for example. In this instance the first user enters the start value key in the first data processing device and the second user the start value key in the second data processing device. There are in addition further options for agreeing the start value key and entering it in the first and second data processing device. The start value key is required only once, namely for the encrypted sending of the start value before or during the first data exchange. It is then no longer required for the generation of the session keys. The personal exchange of a start value key between a first and a second user can serve to authenticate the second user.

According to a further advantageous embodiment of the invention, the start value is formed by a random principle. This random principle may correspond to the random principle according to which the communications server generates the random values. Alternatively it may differ from the random principle of the communications server.

According to a further advantageous embodiment of the invention, first a session key is formed on the communications server using the formation rule, before the unencrypted data is output from the first data processing device to the communications server. This ensures that a session key has already been generated if the unencrypted data of the first data processing device arrives on the communications server. The data can then be encrypted immediately once they have arrived on the communications server. It can therefore be excluded that the data of the first data processing device is permanently saved unencrypted on the communications server.

According to a further advantageous embodiment of the invention, the data of the first data processing device is only permanently saved encrypted on the communications server.

According to a further advantageous embodiment of the invention, the data exchange takes place over a communications link designed as a secure channel of communication between the first data processing device and the communications server, and between the communications server and the second data processing device. The data is therefore protected during sending from the first data processing device to the communications server and during sending from the communications server to the second data processing device along the secure channel of communication. The fact that the data is only permanently saved encrypted on the communications server means it is also protected during saving on the communications server by the session key.

According to a further advantageous embodiment of the invention, the first data processing device outputs a message to the second data processing device if data of the first data processing device that is intended for the second data processing device is encrypted with a session key and saved on the communications server.

According to a further advantageous embodiment of the invention, the communications server outputs a message to the second data processing device if data of the first data processing device that is intended for the second data processing device is saved encrypted on the communications server.

According to a further advantageous embodiment of the invention, the second data processing device repeatedly sends a query to the communications server at time intervals to establish whether data intended for the second data processing device is saved on the communications server. If data for the second data processing device is saved on the communications server, the query by the second data processing device prompts the generation of a session key for the decryption of the data, and the subsequent decryption of the data starts. The same can apply for the first data processing device.

According to a further advantageous embodiment of the invention, a user of the first data processing device and a user of the second data processing device participate in the exchange of data which is encrypted with an automatically generated session key. In the following, the user of the first data processing device is referred to as first user. In addition, the user of the second data processing device is referred to as second user. Here, the first user has an individual address, which is referred to as first individual address. The second user has an individual address, which is referred to as second individual address. If the first user uses the first data processing device to make encrypted data available on the communications server for the second user, the first data processing device sends the second individual address to the communications server. If the communications server supplies a notification that encrypted data of the first data processing device is saved on the communications server for the second data processing device, this notification can be sent to the second individual address. If the second user calls up this message at the second data processing device or at another data processing device, with the help of the second data processing device in dialogue with the communications server they can generate a session key, decrypt the data saved on the communications server and retrieve it from the communications server, using the start value saved on the second data processing device. Retrieval of the notification can be performed on any data processing device. Decryption of the data can only be performed using the second data processing device, because the start value is saved in it. If the second user wishes to retrieve encrypted data with the help of a third data processing device, they must save the start value on this third data processing device. The same applies if encrypted data of the second data processing device for the first data processing device is saved on the communications server. The start value, the first individual address and the second individual address can be saved in a start value file. This start value file can be saved in the first data processing device and in the second data processing device.

According to a further advantageous embodiment of the invention, an individual identifier for the first data processing device and the start value are contained in a first start value file that is saved in the first data processing device. In addition, an individual identifier for the second data processing device and the start value are contained in a second start value file that is saved in the second data processing device. The decryption of data with a session key generated according to the invention is then only possible with the first data processing device if both the start value and the individual identifier for the data processing device match the start value contained in the first start value file and the individual identifier for the first data processing device contained in the first start value file. The same applies to the decryption of data with the second data processing device. Security is increased by saving an individual identifier for the first and second data processing device. Unauthorised third parties are prevented from copying the start value and being able to decrypt data at a further data processing device with the help of this start value.

According to a further advantageous embodiment of the invention, the start value is permanently saved in a memory of the first data processing device and in a memory of the second data processing device. The start value remains the same for several channels of communication.

According to a further advantageous embodiment of the invention, the formation rule is a key derivation function. These functions are defined by cryptographic standards.

According to a further advantageous embodiment of the invention, the method exhibits the following process steps:

Generation of a start value in the first data processing device,

Saving of the start value in a memory of the first data processing device,

Sending of the start value via the communications link to the second data processing device and saving of the start value in a memory of the second data processing device,

Provision of the data saved in the first data processing device and to be transmitted encrypted to the second data processing device for the communications server,

Sending of a notification from the first data processing device to the communications server to indicate that a start value is saved in the first data processing device and that the first data processing device is providing data for encryption and output to the second data processing device,

Generation of a random value in the communications server,

Saving of the random value in the communications server,

Provision of a formation rule in the communications server which generates a session key from at least the start value and the random value,

Generation of a session key from the start value provided by the first data processing device and the random value, using the formation rule,

Encryption of the data provided by the first data processing device with the session key,

Saving of the encrypted data on the communications server,

Provision of a notification by the communications server for the second data processing device to indicate that encrypted data of the first data processing device is saved on the communications server,

Generation of the session key using the formation rule from the start value saved in the memory of the second data processing device and the random value saved in the communications server,

Decryption of the encrypted data with the session key,

Retrieval of the data by the second data processing device, wherein the communications server provides the same random value for a communication process between the first and second data processing device in which the data is encrypted, the encrypted data is saved on the communications server, is retrieved from there again and is decrypted,

wherein the formation rule from matching random values and start values generates the same session key, and wherein for every further communication process between the first and second data processing device a new random value is generated in the communications server and a new session key is generated from the unchanged start value and the new random value using the formation rule.

According to a further advantageous embodiment of the invention, the method exhibits the following process steps in addition to the generation and saving of a start value and the provision of a formation rule:

Process steps concerning the generation of a session key:
Sending of the start value from the first data processing device to the communications server
Saving of the start value in the communications server,
Generation of a random value in the communications server,
Saving of the random value in the communications server,
Generation of a session key from the start value provided by the first data processing device and the random value, using the formation rule, in the communications server,
Saving of the session key on the communications server,

Process steps concerning the encryption of the data with the session key:
Sending of the data saved in the first data processing device and to be transmitted to the second data processing device to the communications server,
Encryption of the data with the session key in the communications server,
Saving of the encrypted data on the communications server,
Deletion of the start value and the session key from the communications server,

Process steps concerning the formation of the session key for decryption of the data:
Sending of the start value from the second data processing device to the communications server,
Saving of the start value on the communications server,
Generation of the session key from the start value sent by the second data processing device and the random value saved in the communications server, using the formation rule, in the communications server,

Process steps concerning the decryption of the data with the session key
Decryption of the data saved on the communications server with the session key,
Sending of the decrypted data to the second data processing device by the communications server,
Deletion of the data, the start value, the session key and the random value from the communications server.

According to a further advantageous embodiment of the invention, the method exhibits the following process steps in addition to the generation and saving of a start value and the provision of a formation rule: Process steps concerning the generation of a session key for the encryption of data:
Sending of the start value from the first data processing device to the communications server
Saving of the start value in the communications server,
Generation of a random value in the communications server,
Saving of the random value in the communications server,
Generation of a session key from the start value provided by the first data processing device and the random value, using the formation rule, in the communications server,

Process steps concerning the encryption of data with the session key
Sending of the session key to the first data processing device,
Encryption of data of the first data processing device with the session key in the first data processing device,
Sending of the encrypted data from the first data processing device to the communications server,
Saving of the encrypted data on the communications server,
Deletion of the start value and the session key from the communications server,

Process steps concerning the formation of a session key for decryption of the data:
Sending of the start value from the second data processing device to the communications server,
Saving of the start value on the communications server,
Generation of the session key from the start value sent by the second data processing device and the random value saved in the communications server, using the formation rule, in the communications server,

Process steps concerning the decryption of the data with the session key
Sending of the session key from the communications server to the second data processing device,
Sending of the encrypted data from the communications server to the second data processing device,
Decryption of the encrypted data with the session key in the second data processing device,
Deletion of the data, the start value, the session key and the random value from the communications server.

According to a further advantageous embodiment of the invention, the method exhibits the following process steps in addition to the generation and saving of a start value and the provision of a formation rule:

Process steps concerning the generation of a session key for the encryption of data:
Generation of a random value in the communications server,
Saving of the random value in the communications server,
Sending of the random value from the communications server to the first data processing device,
Sending of the formation rule from the communications server to the first data processing device,
Generation of a session key from the start value and the random value, using the formation rule, in the first data processing device,

Process steps concerning the encryption of data with the session key:
Encryption of the data with the session key in the first data processing device,
Sending of the encrypted data from the first data processing device to the communications server,
Saving of the encrypted data on the communications server,

Process steps concerning the formation of a session key for decryption of the data:
Sending of the random value from the communications server to the second data processing device,
Sending of the formation rule from the communications server to the second data processing device,
Generation of the session key from the start value and the random value, using the formation rule, in the second data processing device,
Sending of the encrypted data from the communications server to the second data processing device,
Decryption of the data with the session key by the second data processing device,
Deletion of the data and the random value from the communications server.

According to a further advantageous embodiment of the invention, the method exhibits the following process steps in addition to the generation and saving of a start value and the provision of a formation rule:

Process steps concerning the generation of a session key for the encryption of data:
Generation of a random value in the communications server,
Saving of the random value in the communications server,
Sending of the random value from the communications server to the first data processing device,
Generation of a session key from the start value and the random value, using the formation rule, in the first data processing device,

Process steps concerning the encryption of data with the session key:
Encryption of the data with the session key in the first data processing device,
Sending of the encrypted data from the first data processing device to the communications server,
Saving of the encrypted data on the communications server,

Process steps concerning the formation of a session key for decryption of the data:
Sending of the random value from the communications server to the second data processing device,
Generation of the session key from the start value and the random value, using the formation rule, in the second data processing device,

Process steps concerning the decryption of data with the session key:
Sending of the encrypted data from the communications server to the second data processing device,
Decryption of the data with the session key by the second data processing device,
Deletion of the data and the random value from the communications server.

According to a further advantageous embodiment of the invention, the method exhibits the following process steps in addition to the generation and saving of a start value and the provision of a formation rule:

Process steps concerning the generation of a session key for the encryption of data:
Sending of the start value from the first data processing device to the communications server,
Saving of the start value in the communications server,
Generation of a random value in the communications server,
Saving of the random value in the communications server,
Generation of a session key from the start value provided by the first data processing device and the random value, using the formation rule, in the communications server,
Saving of the session key on the communications server, and the following process steps concerning the encryption of the data:
Sending of the data saved in the first data processing device and to be transmitted to the second data processing device to the communications server,
Encryption of the data with the session key in the communications server,
Saving of the encrypted data on the communications server,
Deletion of the start value and the session key from the communications server,

Process steps concerning the formation of a session key for decryption of the data:
Sending of the start value from the second data processing device to the communications server,
Saving of the start value on the communications server,
Generation of the session key from the start value sent by the second data processing device and the random value saved in the communications server, using the formation rule, in the communications server,

Process steps concerning the decryption of data with the session key:
Sending of the session key from the communications server to the second data processing device,
Sending of the encrypted data from the communications server to the second data processing device,
Decryption of the encrypted data with the session key in the second data processing device,
Deletion of the data, the start value, the session key and the random value from the communications server.

Further advantages and advantageous embodiments of the invention can be obtained from the following description, the drawing and the claims.

### Drawing

The drawing shows various model embodiments of the method according to the invention.

FIG. 1 Generation of a session key,

FIG. 2 Encryption of data,

FIG. 3 Decryption of data,

FIG. 4 First model embodiment of the method,

FIG. 5 Second model embodiment of the method,

FIG. 6 Third model embodiment of the method,

FIG. 7 Fourth model embodiment of the method,

FIG. 8 Fifth model embodiment of the method,

FIG. 9 Sixth model embodiment of the method,

FIG. 10 Seventh model embodiment of the method,

FIG. 11 Eighth model embodiment of the method,

FIG. 12 Ninth model embodiment of the method,

FIG. 13 Tenth model embodiment of the method,

FIG. 14 Eleventh model embodiment of the method,

FIG. 15 Twelfth model embodiment of the method,

FIG. 16 Thirteenth model embodiment of the method,

FIG. 17 Fourteenth model embodiment of the method,

FIG. 18 Fifteenth model embodiment of the method,

FIG. 19 Sixteenth model embodiment of the method.

### DESCRIPTION OF THE MODEL EMBODIMENTS

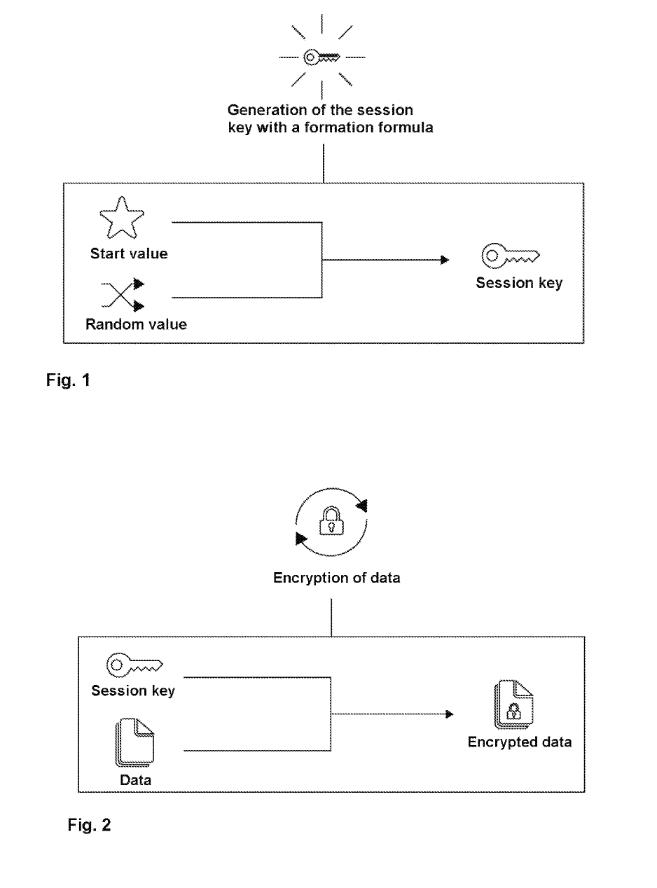

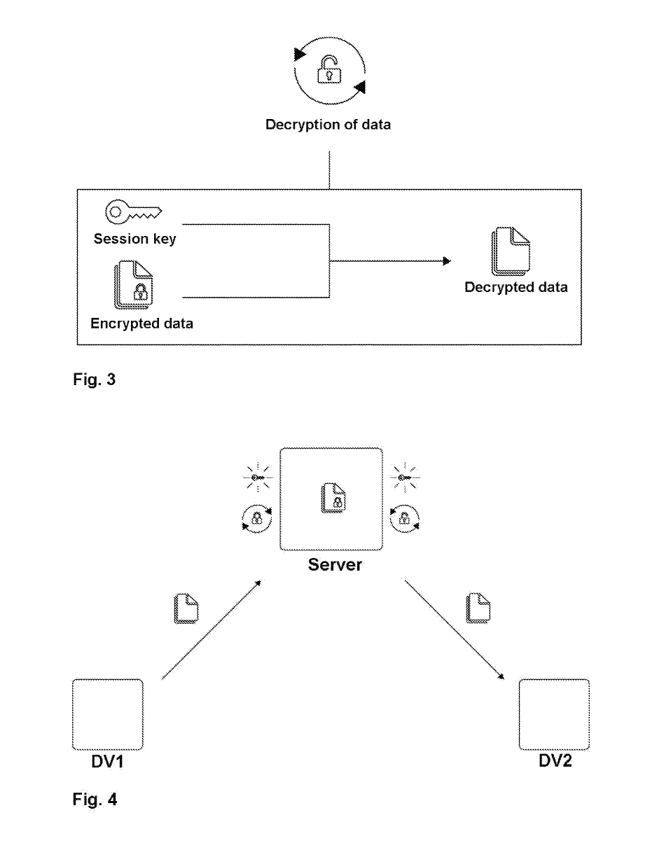

FIG. 1 shows the generation of a session key from a start value and a random value using a formation rule. The start value is symbolised by a star. The random value is represented by two arrows crossing over. The session key is symbolised by a key. Generation of the session key is symbolised by a key from which lines radiate outwards. The start value is saved in a first data processing device and in a second data processing device. These are not represented in FIG. 1. The random value is generated in a communications server. The communications server is not represented in FIG. 1. It is part of a communications link over which the first and the second data processing device are connected to each other. The formation rule is saved in the communications server. The symbol for the session key is also contained in FIGS. 2 and 3. The symbol for the generation of the session key is contained in FIGS. 4 to 19.

FIG. 2 shows the encryption of data. The unencrypted data is symbolised by a stack of paper. The encrypted data is symbolised by a stack of paper with a padlock. The encryption of the data is symbolised by a padlock inside a circle with arrows pointing in the clockwise direction. These symbols for the unencrypted and encrypted data and for the encryption of data are also contained in FIGS. 3 to 19.

FIG. 3 shows the decryption of data. Here, the decryption of data is symbolised by a padlock inside a circle with arrows pointing in the anticlockwise direction.

FIGS. 4 to 19 show sixteen model embodiments of the method for the encryption and decryption of data.

The following table contains a list of the aforementioned sixteen model embodiments. They differ in respect of the devices in which the generation of the session key and the encryption and decryption of the data takes place. The devices here are the communications server, the first data processing device and the second data processing device. The table and FIGS. 4 to 19 show:
the abbreviation server for the communications server,
the abbreviation DV1 for the first data processing device, and
the abbreviation DV2 for the second data processing device.

For the individual lines in the table, the X indicates where the generation of the session key and the encryption and decryption of the data takes place. The number in the first column indicates the number of the model embodiment.

| | Generation | | | | Generation | | | |
|---|---|---|---|---|---|---|---|---|
| | of the session | | Encryption | | of the session | | Decryption | |
| | key for | | of the | | key for | | of the | |
| | encryption | | data | | decryption | | data | |
| Variant | Server | DV1 | Server | DV1 | Server | DV2 | Server | DV2 |
| 1 | X | | X | | X | | X | |
| 2 | X | | X | | X | | | X |
| 3 | X | | X | | | X | X | |
| 4 | X | | X | | | X | | X |
| 5 | X | | | X | X | | X | |
| 6 | X | | | X | X | | | X |
| 7 | X | | | X | | X | X | |
| 8 | X | | | X | | X | | X |
| 9 | | X | X | | X | | X | |
| 10 | | X | X | | X | | | X |
| 11 | | X | X | | | X | X | |
| 12 | | X | X | | | X | | X |
| 13 | | X | | X | X | | X | |
| 14 | | X | | X | X | | | X |
| 15 | | X | | X | | X | X | |
| 16 | | X | | X | | X | | X |

The symbols for the generation of the session key, the encryption of the data and the decryption of the data are represented in FIGS. 4 to 19 in each case next to the device in which the process in question takes place. The arrows between the first data processing device and the communications server as well as between the communications server and the second data processing device symbolise output of the data. If the symbol for the unencrypted data is shown at this arrow, the data is output unencrypted. If the symbol for the encrypted data is shown in this arrow, the data is output encrypted. The output of start value, random value, formation rule or session key is not represented in FIGS. 4 to 19 for the sake of greater clarity. The following applies for all FIGS. 4 to 19:

1. If the session key for the encryption of the data is formed by the communications server, the start value from the first data processing device to the communications server is output, which then forms the session key, from the random value it forms and the start value, using the formation rule.

2. If the session key for the decryption of the data is formed by the communications server, the start value from the second data processing device to the communications server is output, which then forms the session key, from the random value it saves and the start value, using the formation rule.

3. If the session key for the encryption of the data is formed by the first data processing device, the random value formed by the communications server and the formation rule are output from the communications server to the first data processing device. These form the session key from their start value and the random value, using the formation rule.

4. If the session key for the decryption of the data is formed by the second data processing device, the random value saved by the communications server and the formation rule are output from the communications server to the second data processing device. These form the session key from their start value and the random value, using the formation rule.

5. If the key for the encryption of the data is generated by the communications server and if encryption also takes place there, the session key for the encryption of the data need not be output to the first data processing device. The same applies to the session key for the decryption of the data and the second data processing device if the generation of the session key for the decryption of the data and decryption is performed by the communications server.

6. If the key for the encryption of the data is generated by the first data processing device and if encryption also takes place there, the session key for the encryption of the data need not be output to the communications server. The same applies to the decryption of the data by the second data processing device if the session key is formed and the data decrypted there.

7. If the key for the encryption of the data is generated by the communications server and if the encryption of the data takes place in the first data processing device, the session key must be output from the communications server to the first data processing device.

8. If the key for the encryption of the data is generated by the first data processing device and if the encryption of the data takes place in the communications server, the session key must be output from the first data processing device to the communications server.

9. If the key for the decryption of the data is generated by the communications server and if the decryption of the data takes place in the second data processing device, the session key must be output from the communications server to the second data processing device.

10. If the key for the decryption of the data is generated by the second data processing device and if the decryption of the data takes place in the communications server, the session key must be output from the second data processing device to the communications server.

FIG. 4 shows a first model embodiment. In this, the data is output unencrypted from the first data processing device to the communications server. In addition, the start value is output from the first data processing device to the communications server. The latter forms a session key from the start value of the first data processing device and the random value formed by it, encrypts the data with this session key and saves the encrypted data. To decrypt the data, the second data processing device outputs its start value to the communications server. The latter forms a session key from the random value that is still saved and the start value of the second data processing device and decrypts the data before this unencrypted data is output to the second data processing device.

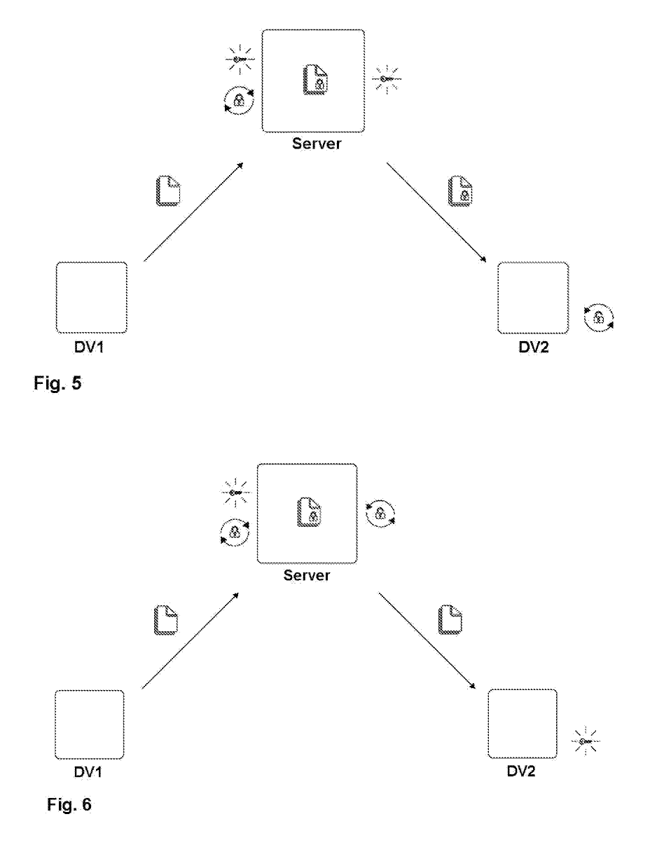

The second model embodiment according to FIG. 5 differs from the first model embodiment in that the decryption of the data takes place in the second data processing device. Here, the session key formed in the communications server for decrypting the data is output to the second data processing device. The data is output encrypted from the communications server to the second data processing device and decrypted there with the session key.

The third model embodiment according to FIG. 6 differs from the first model embodiment in that the generation of the session key for the decryption of the data takes place in the second data processing device. Here, the formation rule and the random value are output from the communications server to the second data processing device. The session key for decrypting the data is then output from the second data processing device to the communications server, which decrypts the data with this session key.

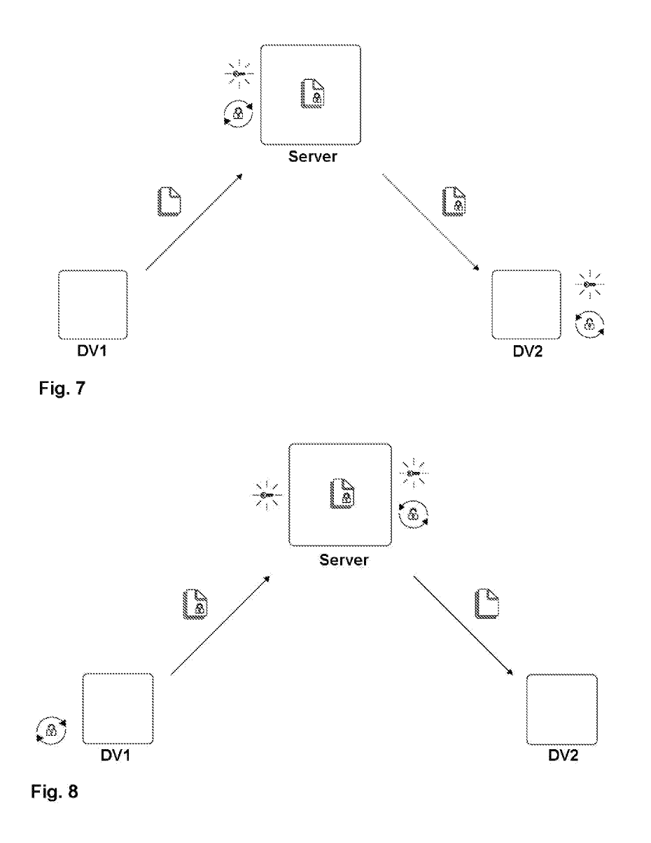

The fourth model embodiment according to FIG. 7 differs from the first model embodiment according to FIG. 4 in that the second data processing device generates the session key and that the second data processing device decrypts the data.

The fifth model embodiment according to FIG. 8 differs from the first model embodiment according to FIG. 4 in that the encryption of the data takes place in the first data processing device.

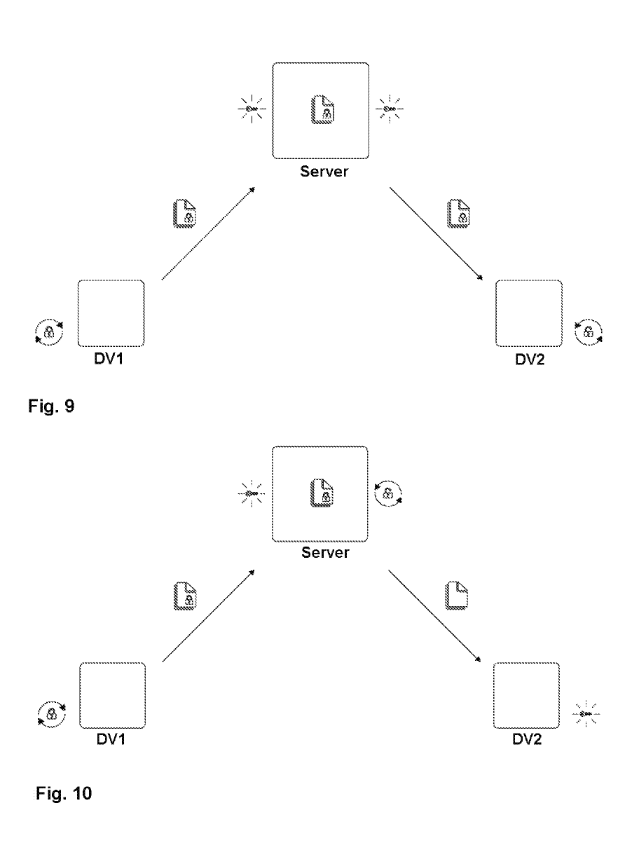

The sixth model embodiment according to FIG. 9 corresponds to the second model embodiment according to FIG. 5, with the difference that the encryption of the data takes place in the first data processing device.

The seventh model embodiment according to FIG. 10 corresponds to the third model embodiment according to FIG. 6, with the difference that the encryption of the data takes place in the first data processing device.

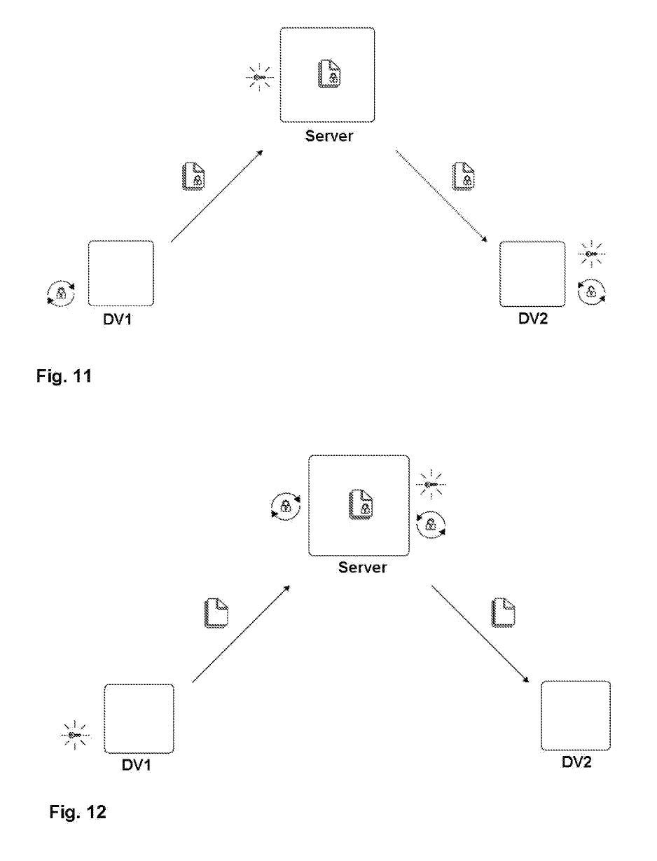

The eighth model embodiment according to FIG. 11 corresponds to the fourth model embodiment according to FIG. 6, with the difference that the encryption of the data takes place in the first data processing device.

The ninth model embodiment according to FIG. 12 differs from the first model embodiment according to FIG. 4 in that the generation of the session key for the encryption of the data takes place in the first data processing device.

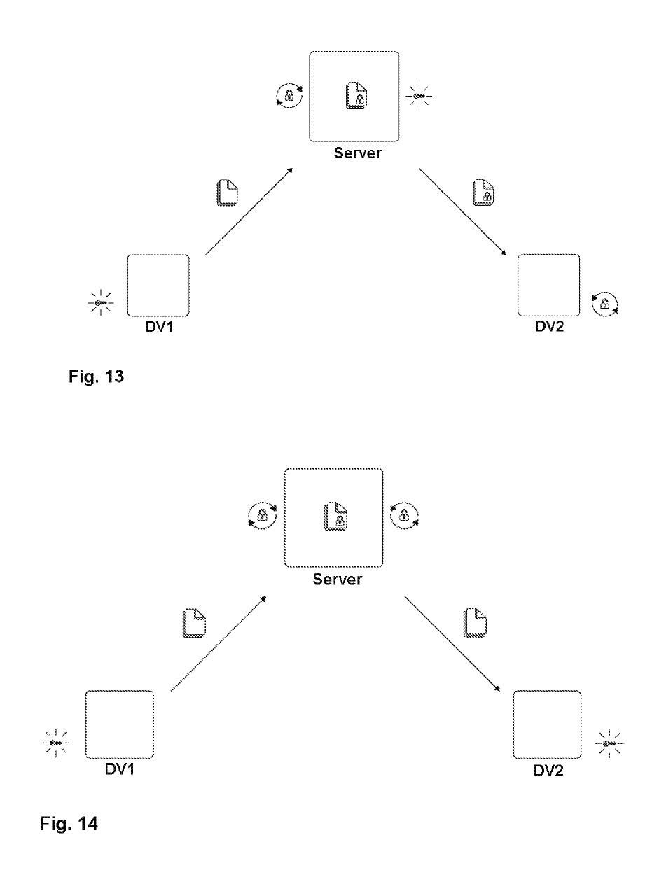

The tenth model embodiment according to FIG. 13 differs from the second model embodiment according to FIG. 5 in that the generation of the session key for the encryption of the data takes place in the first data processing device.

The eleventh model embodiment according to FIG. 14 differs from the third model embodiment according to FIG. 6 in that the generation of the session key for the encryption of the data takes place in the first data processing device.

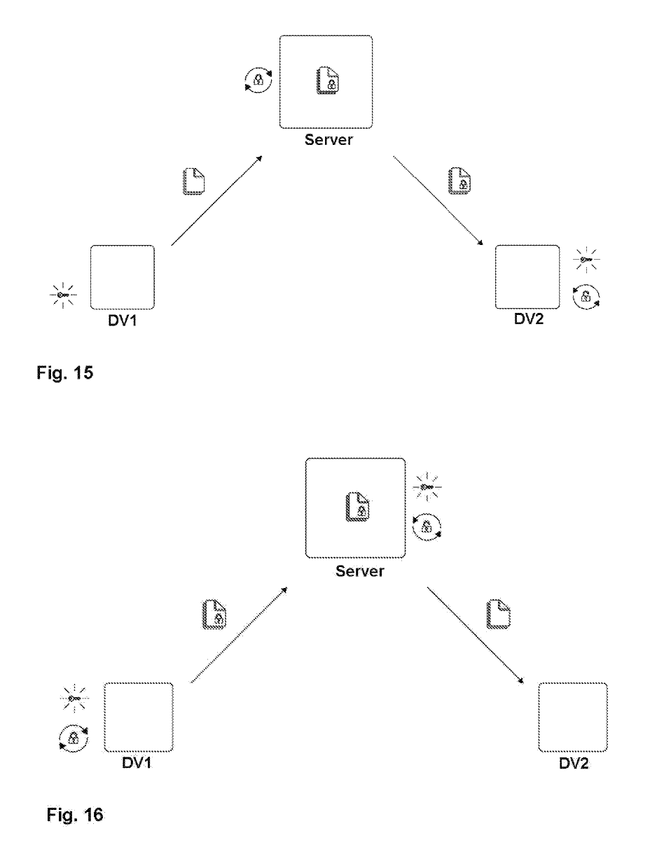

The twelfth model embodiment according to FIG. 15 differs from the fourth model embodiment according to FIG. 7 in that the generation of the session key for the encryption of the data takes place in the first data processing device.

The thirteenth model embodiment according to FIG. 16 differs from the fifth model embodiment according to FIG. 8 in that the generation of the session key for the encryption of the data takes place in the first data processing device.

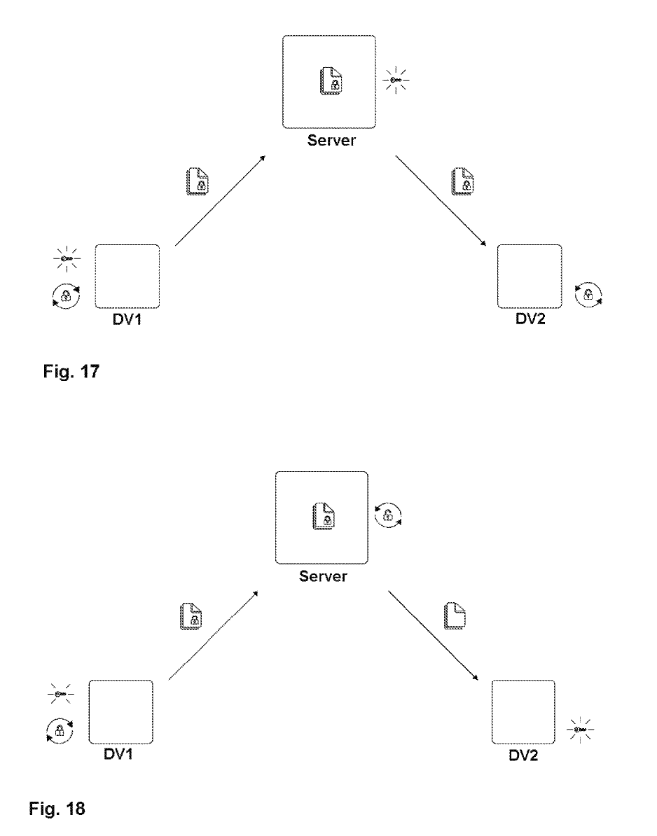

The fourteenth model embodiment according to FIG. 17 differs from the sixth model embodiment according to FIG. 9 in that the generation of the session key for the encryption of the data takes place in the first data processing device.

The fifteenth model embodiment according to FIG. 18 differs from the seventh model embodiment according to FIG. 10 in that the generation of the session key for the encryption of the data takes place in the first data processing device.

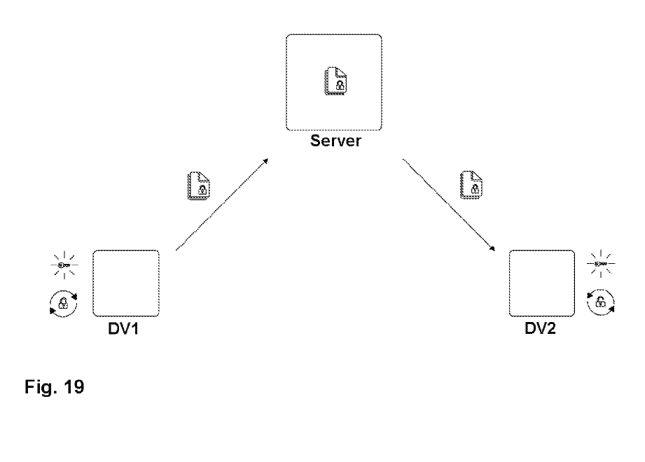

The sixteenth model embodiment according to FIG. 19 differs from the eighth model embodiment according to FIG. 11 in that the generation of the session key for the encryption of the data takes place in the first data processing device.

All features of the invention can be material to the invention both individually and in any combination.

1. Method for encrypting and decrypting data which is exchanged between a first data processing device and a second data processing device via a communications link, with a session key, wherein the first data processing device is connected to the second data processing device via the communications link and the communications link exhibits a communications server, comprising the following process steps concerning the generation of a permanent common start value and the provision of a formation rule for the session key:
Generation of a start value in the first data processing device,
Saving of the start value in a memory of the first data processing device,
Exchanging of this start value between the first and second data processing device,
Provision of a formation rule in the communications server which generates a session key from at least the start value and a random value generated in the communications server,
and the following process steps concerning the generation of a session key for the encryption of the data:
Generation of a random value in the communications server,
Saving of the random value in the communications server,
Either output of the start value by the first data processing device to the communications server and generation of a session key from the start value and the random value by the communications server using the formation rule
Or output of the random value and the formation rule by the communications server to the first data processing device and generation of a session key from the start value and the random value by the first data processing device using the formation rule,
and the following process steps concerning the encryption of data of the first data processing device using the session key:
Encryption of the data using the session key on the communications server or encryption of the data using the session key in the first data processing device and Output of the encrypted data to the communications server,
Saving of the encrypted data on the communications server,
Deletion of the session key,
and the following process steps concerning the generation of a session key for the decryption of the data:
Either output of the start value from the second data processing device to the communications server and generation of the session key from the start value and the random value saved on the communications server by the communications server using the formation rule
Or output of the random value and the formation rule from the communications server to the second data processing device and generation of the session key from the start value and the random value by the second data processing device using the formation rule,
and the following process steps concerning the decryption of the data
Either decryption of the encrypted data with the session key by the communications server and output of the decrypted data to the second data processing device
Or output of the encrypted data to the second data processing device and decryption of the data in the second data processing device using the session key,
Deletion of the session key and the random value.

2. Method according to claim 1, wherein a start value key for encrypting the start value is generated, that the start value is encrypted by the first data processing device using the start value key before it is output to the second data processing device, that the start value key is input into the second data processing device along a channel of communication other than the communications link, and that the encrypted start value in the second data processing device is decrypted using the start value key.

3. Method according to claim 1, wherein the start value is formed according to a random principle.

4. Method according to claim 1, wherein first a session key is formed on the communications server using the formation rule, before the unencrypted data is output from the first data processing device to the communications server.

5. Method according to claim 1, wherein the data exchange takes place over a communications link designed as a secure channel of communication between the first data processing device and the communications server, and between the communications server and the second data processing device.

6. Method according to claim 1, wherein the first data processing device outputs a message to the second data processing device if data of the first data processing device that is intended for the second data processing device is encrypted with a session key and saved on the communications server.

7. Method according to claim 1, wherein the communications server outputs a message to the second data processing device if data of the first data processing device that is intended for the second data processing device is saved encrypted on the communications server.

8. Method according to claim 1, wherein the start value in a memory of the first data processing device and in a memory of the second data processing device is permanently saved and remains constant for several communication processes.

9. Method according to claim 1, wherein the formation rule is a key derivation function.
